(19) United States
(12) Patent Application Publication
(10) Pub. No.: US 2014/0307780 A1
(43) Pub. Date: Oct. 16, 2014

(54) Method for Video Coding Using Blocks Partitioned According to Edge Orientations

(71) Applicant: MITSUBISHI ELECTRIC RESEARCH LABORATORIES, INC., Cambridge, MA (US)

(72) Inventors: Robert A. Cohen, Somerville, MA (US); Sudeng Hu, Los Angeles, CA (US); Anthony Vetro, Arlington, MA (US)

(73) Assignee: Mitsubishi Electric Research Laboratories, Inc., Cambridge, MA (US)

(21) Appl. No.: 13/860,782

(22) Filed: Apr. 11, 2013

(51) Int. Cl. H04N 19/124; H04N 19/61

(52) U.S. Cl. CPC H04N 19/0009; H04N 19/00781
USPC 375/240.03

(57) ABSTRACT

A bitstream corresponding to an encoded video is decoded. The encoded video includes a sequence of frames, and each frame is partitioned into encoded blocks. For each encoded block, an edge mode index is decoded based on an edge mode codeword and a prediction mode. The edge mode index indicates a subset of predetermined partitions selected from a partition library according to the prediction mode. The encoded block is partitioned based on the edge mode index to produce two or more block partitions. To each block partition, a coefficient rearrangement, an inverse transform and an inverse quantization is applied to produce a processed block partition. The processed block partitions are then combined into a decoded block for a video.

### FIELD OF THE INVENTION

This invention relates generally to video coding, and more particularly to partitioning and transforming blocks.

### BACKGROUND OF THE INVENTION

When videos, images, or other similar data are encoded or decoded, previously-decoded or reconstructed blocks of data are used to predict a current block being, encoded or decoded. The difference between the prediction block and the current block or reconstructed block in the decoder is a prediction residual block.

In an encoder, a prediction residual block is a difference between the prediction block and the corresponding block from an input picture or video frame. The prediction residual is determined as a pixel-by-pixel difference between the prediction block and the input block. Typically, the prediction residual block is subsequently transformed, quantized, and then entropy coded for output to a file or bitstream for subsequent use by a decoder.

FIG. 1 shows a conventional the decoder input is a bitstream 101, which is parsed and entropy decoded 110 to produce a quantized transformed prediction residual block 102, which is inverse quantized 120. A prediction mode 106 is also parsed and entropy decoded 110 from the input bitstream 101. An inverse transform 130 is applied to obtain a decoded prediction residual 103 to which a pixel-by-pixel sum calculation is applied 140 to output a reconstructed block 104 for the output video 105. The reconstructed block is stored 150 in a buffer as a previous block, and is used for a prediction 160 according to a prediction mode 106 for the sum calculation applied to the next current block.

The conventional decoder described above is according to existing video compression standards such as the HEVC or H.264/AVC. In the decoder specified by the HEVC text specification draft 10, previously-decoded blocks, also known as reconstructed blocks, are put through a prediction process in order to generate the prediction block. The decoder also parses and decodes a bitstream, followed by an inverse quantization and inverse transform, in order to obtain a quantized prediction residual block. The pixels in the prediction block are added to those in the prediction residual block to obtain a reconstructed block for the output video.

In a typical video or image compression system used to compress natural scenes, i.e., scenes that are typically acquired by a camera, pixels in neighboring blocks are usually more highly-correlated than pixels in blocks located far from each other. The compression system can leverage this correlation by using nearby reconstructed pixels or blocks to predict the current pixels or block in video coders such as H.264 and High Efficiency Video Coding (HEVC), the current block is predicted using reconstructed blocks adjacent to the current block; namely the reconstructed block above and to the left of the current block.

Because the current block is predicted using neighboring reconstructed blocks, the prediction is accurate when the pixels in, the current block are highly-correlated to the pixels in the neighboring reconstructed block. The prediction process in video coders such as H.264 and HEVC have been optimized to work best when pixels or averaged pixels from the reconstructed block above and/or to the left can be directionally propagated over the area of the current block. These propagated pixels become the prediction block.

However, this prediction fails to perform well when the characteristics of the current block differ greatly from those used for prediction. While the conventional methods of prediction can perform well for natural scenes containing soft edges and smooth transitions, those methods are poor at predicting blocks containing sharp edges, such as can be found in graphics or text, where a strong or sharp edge can occur in the middle of a block, thus making it impossible to predict from neighboring previously-decoded blocks. Within the HEVC framework, the prediction mode oriented, along the edge is likely to produce less residual energy than a mode that predicts across the edge, as pixel values from neighboring blocks used during the prediction process are not good predictors of pixels on the opposite side of an edge.

With conventional methods, one two-dimensional transform is applied to the entire block. The edge contained in the block increases the number of frequency components present in the transformed block, thus reducing compression efficiency. Additionally, the prediction from the neighboring blocks determined by extending neighboring pixels along a direction through the current block mean that the prediction can be crossing edge boundaries, leading to a larger prediction error when compared to predicting a smooth block.

Attempts have been made to address the problem of predicting a block with edges, for example. U.S. 2009/0268810 describes geometric intra prediction. That method applies different parametric models over different partitions of a block, to form a prediction. A system using that method, however, incurs a significant increase in complexity because the new prediction method requires a rate-distortion (RD) optimized selection of prediction be performed over a set of parametric models, and applying a transform over a block comprising partitions that were determined using a variety of parametric models can still be inefficient due to discontinuities between those partitions used for prediction.

Determining polynomials and their associated parameters based on the contents of the block also significantly increases the complexity of an encoder/decoder (codec) system. The size of the bitstream also increases significantly because parameters associated with those polynomials need to be signaled. Furthermore, such a system requires a significant change from the current prediction method specified by the existing H.264 and HEVC standards.

Other techniques to improve the coding of directional features in predicted blocks exist, such as U.S. Pat. No. 8,406,299, which describes directional transforms for coding prediction error blocks. That method selects a transform based on the prediction mode. The transform is designed or selected to improve the coding efficiency when operating on blocks predicted using the given prediction direction or mode. That method, however, still applies a transform over a prediction error block determined as the difference between the image block and a predicted block. Because the prediction that generates the predicted block cannot anticipate a new edge appearing in the current block, the transform is still applied across or over the edge, resulting in potential reduction in coding efficiency due to an increase in the number of high-frequency transform components.

None of the prior art anticipates the concept that:, given the existing method for spatial prediction used in coders such as H.264 and HEVC, the presence of an edge can influence the optimal prediction direction. There is a need, therefore, for a method that improves the coding efficiency of a block-based video coding system so that the existing coding systems can be improved without the need to change their prediction methods.

### SUMMARY OF THE INVENTION

Some embodiments of the invention are based on a realization that various encoding/decoding techniques based on determining a prediction residual between a current input block and neighboring reconstructed blocks do not produce good results when data in the current block contains sharp transitions, e.g., smooth areas of differing intensities that share a common boundary, which cause the data to be sufficiently different from the contents of neighboring reconstructed blocks that are used to predict the current block. When a transform is applied over an entire prediction residual block, which is the difference between the input block and its prediction, the sharp transitions lead to inefficiencies in coding performance,

If, however, the prediction residual block is partitioned along the sharp transition or thin edges, the transforms can be applied separately to each partition, thus reducing the energy in the high-frequency transform coefficients when compared to applying the transform over the entire prediction residual block. In other words, partitioning is along the thin edge. In essence the block is “cut” at the thin edge.

Statistical dependencies between the optimal partitioning orientation and the prediction direction can be leveraged to limit the number of different partitioning modes that need to be tested or signaled in an encoding, and decoding system. For example, if the optimal prediction mode is horizontal or vertical, then the potential partitioning directions can be limited to horizontal and vertical partitions. If the optimal prediction is oblique, then the potential partitioning directions can be limited to oblique modes.

In addition to reducing the complexity of encoding and decoding systems, this relation between the prediction direction and optimal partitioning mode reduces the number of modes that must be signaled in the bitstream, thus reducing the overall bit-rate or file size representing the coded image or video.

### BRIEF DESCRIPTION OF THE DRAWINGS

FIG. 1 is a block diagram of a conventional decoder;

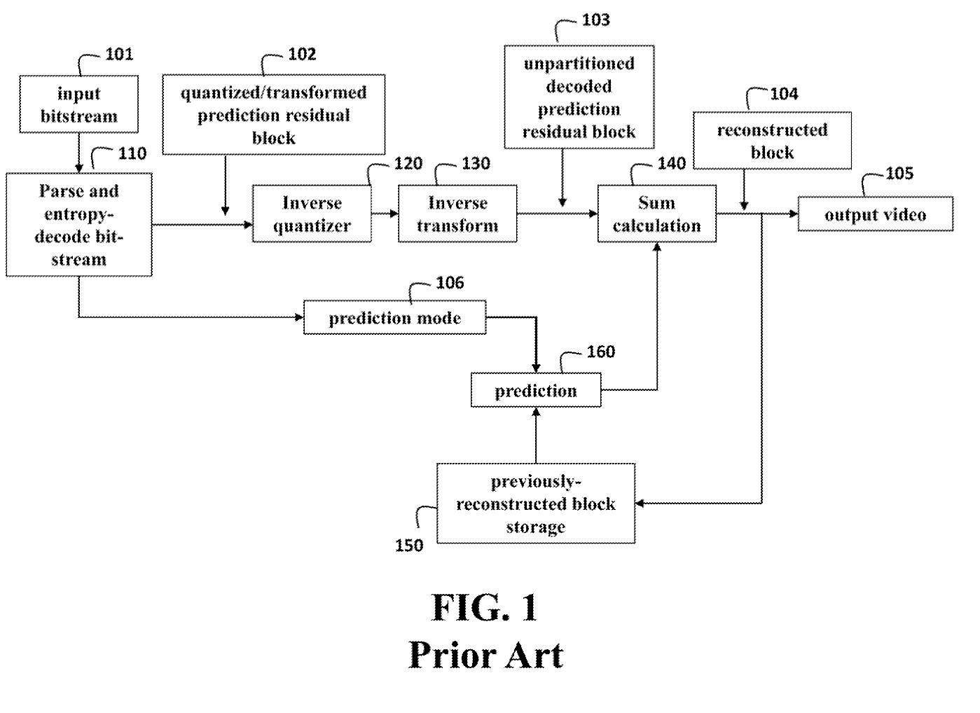

FIG. 2 is a block diagram of a block partitioning subsystem of a decoder and a partial decoder according to embodiments of the invention;

FIG. 3 is a block diagram of a decoder according to embodiments of the invention;

FIG. 4 is a schematic of a block combiner according to embodiments of the invention;

FIG. 5 is a diagram of an encoder according to the embodiments of the invention; and

FIG. 6 is a table of mappings between edge codes and edge modes according to embodiments of the invention.

### DETAILED DESCRIPTION OF THE PREFERRED EMBODIMENTS

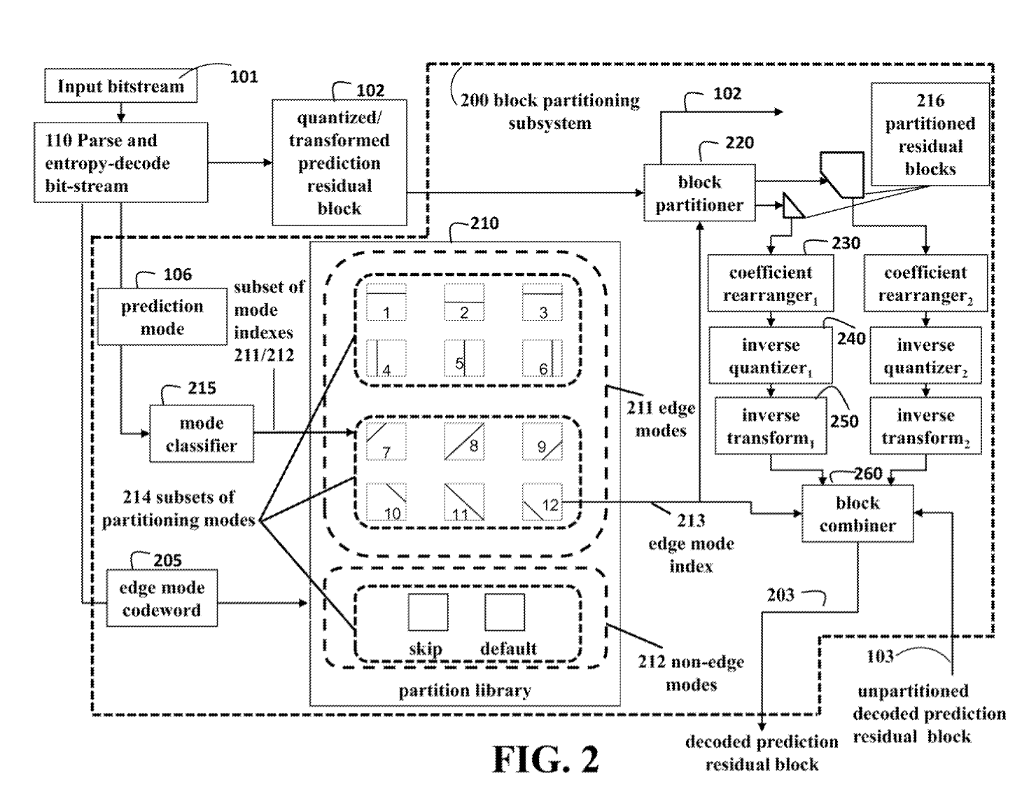

FIG. 2 schematically shows a block partitioning subsystem 200 of a video decoder according to the embodiments of the invention. The input bitstream 101 is parsed and entropy decoded 110 to produce a quantized and transformed prediction residual block 102, a prediction mode 106 and an edge mode codeword 205, in addition to other data needed to perform decoding.

The block partitioning subsystem has access to a partition library 210, which specifies a set of modes. These can be edge modes 211, which partition a block in various ways, or non-edge modes 212 which do not partition a block. The non-edge modes can skip the block or use some default partitioning. The figure shows twelve example edge mode orientations. The example partitioning is for the edge mode block having an edge mode index 213.

Edge modes or non-edge modes can also be defined based on statistics measured from the pixels in the block. For example, the gradient of data in a block can be measured, and if the gradient exceeds a threshold, the partitions can be defined as a splitting the block at an angle that is aligned or perpendicular to the steepest gradient in the block. Another example partitioning mode can be dividing the block in half if the variance of data in one half of the block is significantly different from the variance of data in the other half of the block.

The subsets of partitions in the library can also be defined based upon the number of partitions. For example, one subset can contain modes that divide a block into two partitions; a second subset can contain modes that divide a block into three partitions, etc.

The organization of subsets of the partition library can also be altered by previously decoded data For example, one arrangement of subsets can be selected for intra-coded pictures, and a different arrangement can be selected for use with intra-coded pictures. Furthermore, the subsets of modes can be rearranged or altered based upon how often each mode was used for decoding previous block. For example, the modes can be arranged in descending, order starting with the most frequently-used mode, and ending with the least-frequently used mode. Furthermore, the rearranged modes can be divided into subsets. For example, a subset of modes in the partition library can be defined to contain the ten most-frequently used modes up to this point in the decoding process.

If during the decoding process, some modes in the partition library are not used, or if the number of times they are used is below a threshold, then those modes can be removed from the partition library. Subsequently decoded blocks or pictures will therefore not use the removed modes, and the side-information associated with those modes will not need to be signaled.

The current prediction mode 106 is input to a mode classifier 215. The mode classifier selects among a subset of partitioning modes 214 from the partition library 210 to be used for further processing. The edge mode codeword 205 is a pointer to one of the modes contained in this subset of modes. Thus, the edge mode codeword 205 can be mapped to the edge mode index 213, which represents the mode from the partition library is to be used by the decoder for the current block.

A block partitioner 220 outputs either each partition of the quantized and transformed prediction residual block 102 according to the edge mode index 213, or it passes through the unpartitioned quantized and transformed prediction residual block 102, depending on whether the edge mode index represents an edge mode or lion-edge mode, respectively.

Each partitioned residual block 216 output from the block partitioner 220 is processed by a coefficient rearranger 230, an inverse quantizer 240, and an inverse transform 250.

Under certain conditions, such as, if the number of pixels in a partition are below a threshold, a partition can be discarded. In this case, that particular partition will not be further processed by the coefficient rearranger, inverse quantizer, and inverse transform. The block combiner 260 will fill in the missing data corresponding to the discarded block with pixels that are computed based on previously decoded data, such as the average value of pixels in the neighbouring non-discarded partition.

The coefficient rearranger 230 changes the order of the coefficients represented in the partitioned residual block 216, prior to inverse quantization. This rearrangement reverses the rearranging performed by an encoder when the bitstream 101 was generated. The rearrangement performed by the encoder is typically done to improve the coding efficiency of the system. The specific type of rearrangement can be determined by several different parameters, including the prediction mode 106 and the edge mode index 213. Subsequent processes, such as the inverse quantizer 240 and inverse transform 250 can also be controlled by these parameters.

The inverse quantizer 240 adjusts the values of the rearranged coefficients prior to performing an inverse transform. The inverse transform 250 can be a single transform operating on a one-dimensional rearrangement of inverse quantized coefficients, or it can be a multidimensional inverse transform. An example of a multidimensional inverse transform is a set of coaligned one-dimensional transforms applied aligned with the angle at: which the block was partitioned, followed by set of coaligned one-dimensional transforms applied perpendicular to the angle of partitioning.

Another example can be where first transform from the second set of one-dimensional transforms is applied to the coefficients in the partition that represent the lowest frequency or Direct Current (DC) transform coefficients, and the subsequent one-dimensional transforms are applied to successively higher-frequency coefficients. Thus, the coefficient rearrangement, inverse quantization, and inverse transform methods can differ depending on how the block is partitioned, and different versions of these methods can be defined for a given partitioning.

The example in FIG. 2 shows two partitions, but other numbers of partitions are possible as well. The partition library 210 can also contain edge modes 211 having varying numbers of partitions. For example, some edge modes can partition a block into three or more partitions.

Alter the partitioned blocks are inverse transformed, the blocks are combined into a whole block in a block combiner 260, which uses the edge mode index 21 3 to reassemble the block corresponding to the way the block was partitioned by the block partitioner 220. If the edge mode index 213 corresponds to a mode that does not partition a block, then the block combiner passes an unpartitioned decoded prediction residual block. 103.

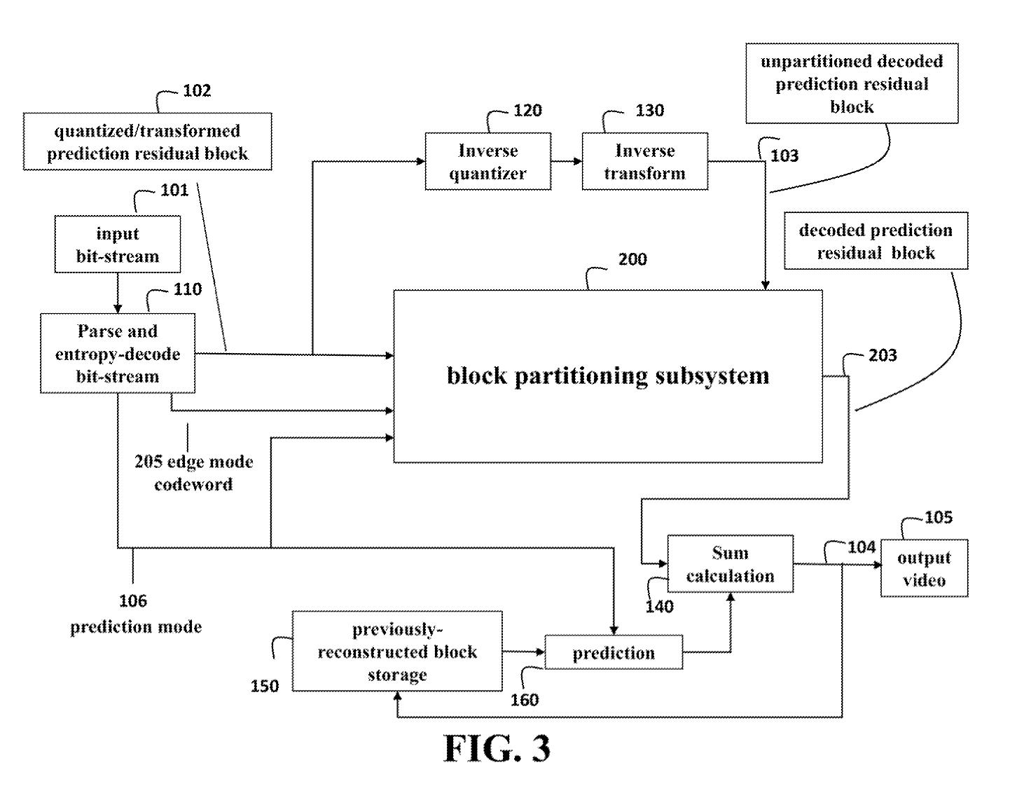

FIG. 3 shows a schematic of a decoder according to the embodiments of the invention. The decoder parses and decodes the bitstream 101, producing several data including the quantized and transformed prediction residual block 102, which was previously transformed and quantized, the prediction mode 106, and the edge mode codeword 205. These data are input to the block partitioning subsystem 200, which outputs the decoded prediction residual block 203. The prediction mode 106 is also used to generate the prediction 160 based on data contained in previously-reconstructed blocks 150. The prediction 160 and the decoded prediction residual block 203 undergo the sum calculation 140 to produce a reconstructed block 104, which is used for the output video 105. The reconstructed block 104 is also stored 150, to be used to predict future blocks. The edge mode index 213 used by the block partitioning subsystem. 200 can also be used throughout various parts of the mode-controlled inverse process as an indicator as to which mode from the partition library 210 is being used.

The above steps, as well as processes described below and in other figures, can be performed in a processor, typically an encoder and decoder (codec) connected to memories (buffers), and input and output interfaces as known in the art.

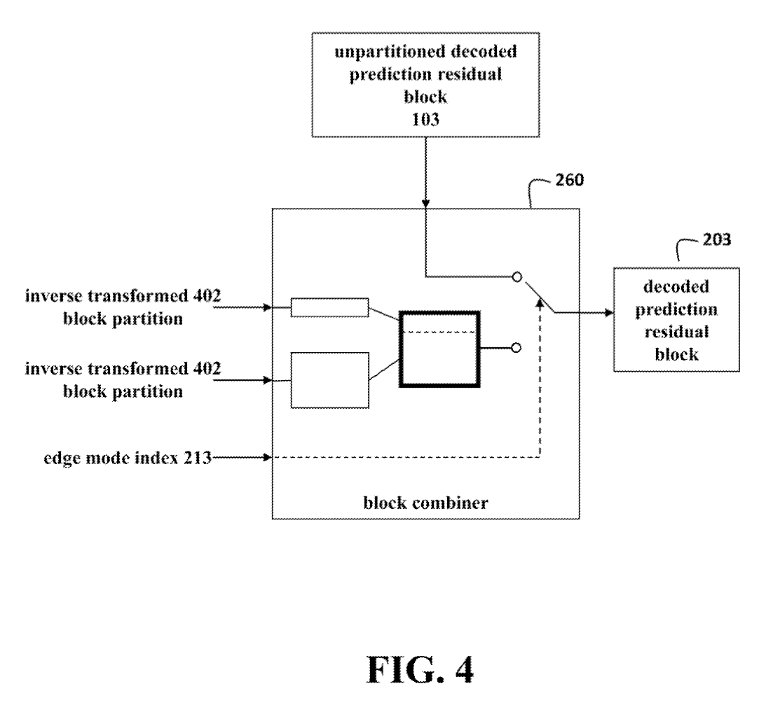

FIG. 4 shows the block combiner 260 according to the embodiments of the invention. If the current edge mode index 213 represents the edge mode 211, then the block combiner combines the two input partitioned blocks 402 into one complete block. If the current edge mode index represents a non-edge mode 212, then the unpartitioned decoded prediction residual block 103 is passed through. The output of the block combiner 203 is thus a complete block, representing the decoded prediction residual block in this case.

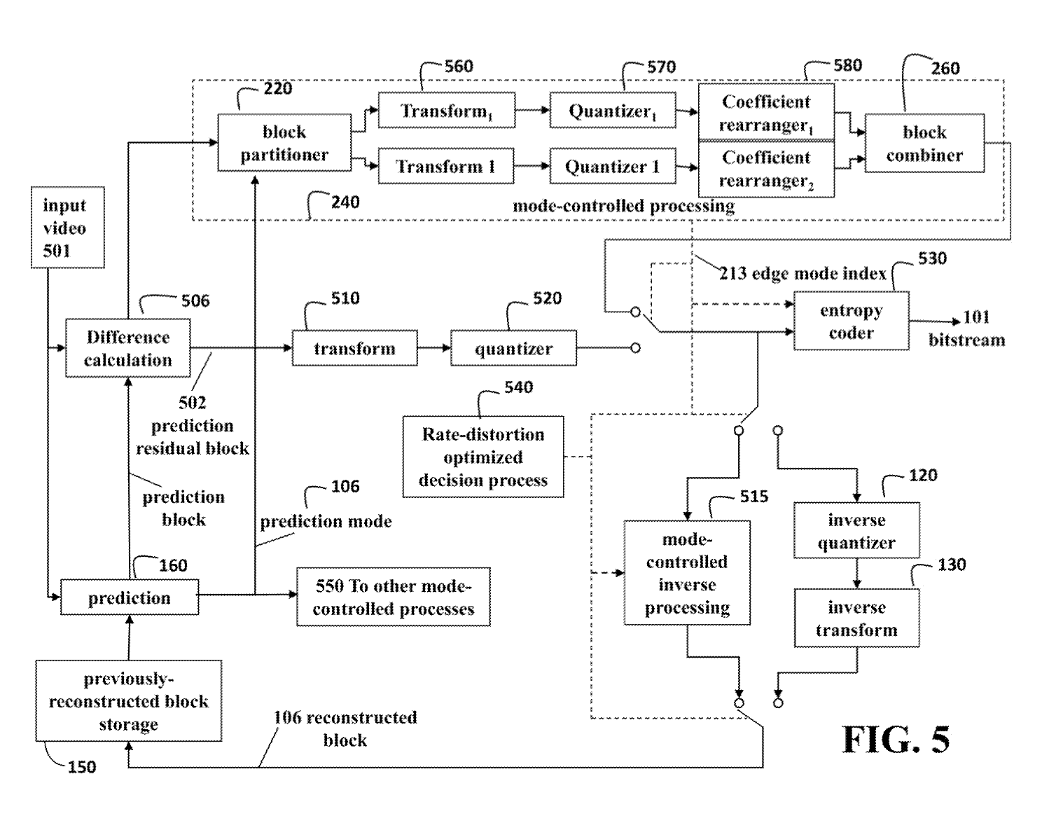

FIG. 5 shows an encoder according to the embodiments of the invention. Previously reconstructed blocks 150 are used by the prediction process 160 to form a prediction block according to the prediction mode 106. The prediction block is an approximation of the current input block. A difference calculation 506 is used to determine the prediction residual block 502, which is the difference between the input video block 501 and its prediction block. A rate-distortion optimized decision process is used to test several prediction modes, among other things, in order to determine the best prediction mode. The prediction can also be used by other mode controlled processes 550.

The prediction residual block is passed to a transform 510 and quantizer 520 process similar to the processes used in typical encoding systems. Additionally, the prediction residual block is passed to the mode-controlled processing 580, which is similar to the mode-controlled inverse processing system of the decoder, except the transforms, quantization, and coefficient rearranging are inverted. Thus, a block partitioner 220 partitions the current prediction residual block, and then the partitions are transformed 560, quantized 570, and rearranged 580.

This partitioned data are then combined 260 into a complete block. The partitioning and combining are performed according to the edge mode index 213. The encoder can use a rate-distortion optimized decision process 540 to test among several modes in order to determine the best edge mode or non-edge mode index to be used for encoding. This edge mode index is used to control whether the unpartitioned block or partitioned blocks are used throughout the rest of the encoder for processing the current block. The combined or unpartitioned block is entropy coded 530 and signaled in the bitstream 101, which is stored or transmitted for future processing by a decoder or bitstream analysis system

Additionally, the edge mode index 213 associated with each block is entropy coded 530 and signaled as an edge mode in the output bitstream. The edge mode codeword is a mapping from the edge mode index to an edge mode codeword based on the prediction mode.

The encoder also performs the inverse quantization 120 and the inverse transform 130, identical to those found in the decoder, in order to determine a reconstructed block. If the edge mode index corresponds to a partitioned block, then the mode-controlled inverse processing 515 is used to inverse quantize and inverse transform the block. This mode-controlled inverse processing performs steps identical to those found in the block partitioning subsystem 200, namely the block partitioner 220, coefficient rearranger 230, inverse quantizer 240, inverse transform 250, and block combiner 260. Thus, each partition of the current block is inverse processed in the same way the block is processed in the decoder. The reconstructed block 106 output from either the mode-controlled inverse processing 515 or the inverse transform 130 is stored in a buffer for use by the predictor, for predicting future input video blocks.

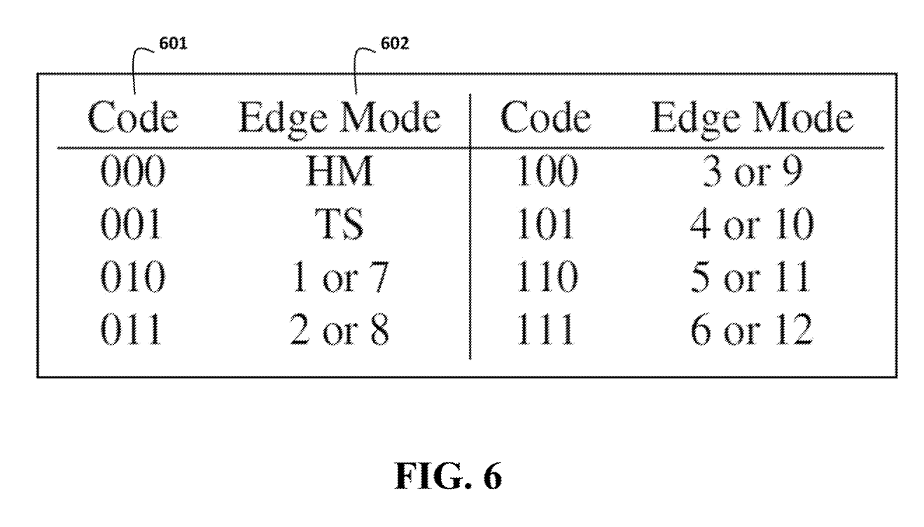

FIG. 6 shows an example mapping according to the embodiments of the invention. The “Code” column 601 indicates a binary codeword that is signaled in the bitstream, as a representation of the edge mode codeword 602. This codeword is mapped to an edge mode or subset of edge modes. The prediction mode 106 is used to control the mode classifier 215 of FIG. 2, to select one of the edge modes from the corresponding “Edge Mode” column.

When rate-distortion optimization is used to select the best intra prediction mode for a given block, it is likely that the edge orientation is in parallel with the intra prediction direction, because predicting across an edge is likely to yield an increased prediction error. What is unknown is the position of the edge within the block. This if the prediction mode represents a horizontal, vertical, or near-horizontal or near-vertical prediction direction, then edge modes 1 through 6, shown for the partition library 210 in FIG. 2, can be selected, as they represent horizontal and vertical partitioning of the block. If, however, the prediction mode represents prediction along an oblique direction, then edge modes 7 through 12 can be selected. Additional non-edge modes can be selected as well. For example, “HM” represents the existing method in the HEVC Test Model reference software HM-1.0, which corresponds to the default processing of an unpartitioned block. “TS” represents the Transform Skip mode of the HEVC Test Model, in which instead of applying a transform similar to the Discrete Cosine Transform, the data in the block is simply scaled.

### Additional Embodiments

FIGS. 2, 4, and 5 show the case when a block can be partitioned into two partitions. Other embodiments can partitioned a block into more than two partitions.

FIG. 2 shows the partition library that contains edge modes and non-edge modes. Other embodiments can include other modes not necessarily associated with the presence of edges. For example, a subset of modes can represent “noisy” blocks which contain no discernible edge but contain significant levels of noise or types of noise in the encoded blocks.

Some steps in both the decoding and encoding processes can be skipped depending on the edge mode index 213. For example, if the current block is partitioned, then the transform and quantization or inverse transform and quantization steps on the unpartitioned block can be skipped, as they will not be used to generate or decode the current block. Similarly, if the current block is unpartitioned, then the block partitioning subsystem, mode-controlled inverse processing, and related processes can be skipped.

The main embodiment describes the used of prediction directions, which is typically associated with intra prediction, i.e., prediction within one frame. Other embodiments can define other types of edge modes for use in non-directional prediction, such as that used for inter-frame prediction. The example of noisy blocks given earlier can apply in this case as well.

Although the invention has been described with reference to certain preferred embodiments, it is to be understood that various other adaptations and modifications can be made within the spirit and scope of the invention. Therefore, it is the object the append claims to cover all such variations and modifications as come within the true spirit and scope of the invention.

We claim:

1. A method for decoding a bitstream, wherein the bitstream corresponds to an encoded video, wherein the encoded video includes a sequence of frames, wherein each frame is partitioned into encoded blocks, for each encoded block comprising the steps of:
decoding, from the encoded block, an edge mode index based on an edge mode codeword and a prediction mode, wherein the edge mode index indicates a subset of predetermined partitions selected from a partition library according to the prediction mode; and
partitioning the encoded block based on the edge mode index to produce two or more block partitions; and
applying, to each block partition according to the edge mode index, a coefficient rearrangement, an inverse transform and inverse quantization to produce a processed block partition; and
combining the processed block partitions into a decoded block.

2. The method of claim 1, wherein the partition library stores edge modes for partitioning the encoded block and non-edge modes for skipping the partitioning of the encoded block, and a default mode.

3. The method of claim 1, further comprising:
classifying the prediction mode to select the subset of predetermined partitions.

4. The method of claim 1, further comprising:
rearranging an order of coefficients in the two or more block partitions to produce two or more rearranged block partitions; and
applying an inverse quantizer and then an inverse transform to the two or more rearranged block partitions.

5. The method of claim 4, wherein the inverse transform performs a one-dimensional rearrangement of inverse quantized coefficients.

6. The method of claim 4, wherein the inverse transform performs a multi-dimensional rearrangement of inverse quantized coefficients coaligned with an angle at which the encoded block is partitioned, followed by set of coaligned one-dimensional transforms applied perpendicular to the angle of partitioning.

7. The method of claim 4, wherein the inverse transform is applied to coefficients that represent lowest frequency or discrete cosine transform coefficients, and subsequent one-dimensional transforms are applied to successively higher-frequency coefficients.

8. The method of claim 4, wherein the rearranging, inverse quantizer, and inverse transform depend on the partitioning.

9. The method of claim 1, wherein the bitstream is generated in an encoder and the bitstream include the edge mode codeword and the prediction mode for each encoded block.

10. The method of claim 2, wherein a subset of the edge modes represent types of noise in the encoded block.

11. The method of claim 1, wherein the steps are performed for intra-frame or inter-frame prediction.

12. The method of claim 2, wherein each edge mode and non-edge mode also has an associated inverse transform.

13. The method of claim 1, wherein the edge mode index is determined in part through a rate-distortion optimization process, in which a cost function, which is a weighted combination of rate and distortion associated with each edge mode, index is minimized.

14. The method of claim 13, wherein weighting in the cost function is a function of the edge mode index.

15. The method of claim 4, wherein the block partition is discarded when a number of pixels in the block partition and statistics of the pixels in is less than a threshold, and the block combiner computes data to fill in for the discarded partition.

16. The method of claim 2, in which the partition library is organized into subsets of modes that represent different statistical characteristics measured over the encoded block.

17. The method of claim 2, in which the partition library is organized into subsets of modes based upon the number of partitions associated with each mode.

18. The method of claim 2, in which the partition library is organized into subsets of modes based on the number of pixels contained in each partition associated with each mode.

19. The method of claim 2, in which the organization of modes in the partition library into subsets is dynamically adjusted based upon previously decoded data.

20. The method of claim 19, in which the organization of modes and the correspondence with subsets in the partition library is dynamically adjusted based upon the number of times each mode was used prior to decoding the encoded block.

21. The method of claim 2, in which modes are added or removed from the partition library for coding future frames, based upon whether the modes were used to code a current frame.
